(19) United States
(12) Patent Application Publication
(10) Pub. No.: US 2026/0270890 A1
(43) Pub. Date: Sep. 10, 2026

(54) POWER HEADROOM REPORTING FOR MULTIPLE CARRIERS

(71) Applicant: QUALCOMM Incorporated, San Diego, CA (US)

(72) Inventors: Xinyu WANG, Beijing (CN); Peng WU, Shanghai (CN); Zhanyi LIU, Beijing (CN); Peng LIU, Xi'an (CN); Brahim SAADI, Nuremberg (DE); Shu ZHANG, Beijing (CN); Enoch Shiao-Kuang LU, San Diego, CA (US); Congchong RU, Beijing (CN); Liang HONG, Beijing (CN); Yuyu YAN, Beijing (CN); Jie MAO, Beijing (CN); Ling XIE, Beijing (CN); Tom CHIN, San Diego, CA (US)

(21) Appl. No.: 19/482,624

(22) PCT Filed: Jun. 30, 2023
(86) PCT No.: PCT/CN2023/104602

§ 371 Date: Nov. 7, 2025

(51) Int. Cl. H04W 52/36; H04L 5/00

(52) U.S. Cl. CPC H04W 52/365; H04L 5/001

(57) ABSTRACT

Various aspects of the present disclosure generally relate to wireless communication. In some aspects, a user equipment (UE) may communicate on a first component carrier (CC) and a second CC. The UE may transmit a first power headroom (PH) report indicating an actual PH value on the first CC. The UE may transmit a second PH report on the second CC, wherein transmitting the PH report on the second CC is associated with at least one of a virtual PH threshold or a timer specific to the second CC. Numerous other aspects are described.

### FIELD OF THE DISCLOSURE

Aspects of the present disclosure generally relate to wireless communication and to techniques and apparatuses for power headroom reporting for multiple carriers.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

Some aspects described herein relate to a method of wireless communication performed by a user equipment (UE). The method may include communicating on a first component carrier (CC) and a second CC. The method may include transmitting a first power headroom (PH) report indicating an actual PH value on the first CC. The method may include transmitting a second PH report on the second CC, wherein transmitting the PH report on the second CC is associated with at least one of a virtual PH threshold or a timer specific to the second CC.

Other aspects provide: an apparatus operable, configured, or otherwise adapted to perform any one or more of the aforementioned methods and/or those described herein with reference to and as illustrated by the drawings; a non-transitory, computer-readable medium comprising computer-executable instructions that, when executed by a processor of an apparatus, cause the apparatus to perform the aforementioned methods and/or those described herein with reference to and as illustrated by the drawings; a computer program product embodied on a computer-readable storage medium comprising code for performing the aforementioned methods and/or those described herein with reference to and as illustrated by the drawings; and/or an apparatus comprising means for performing the aforementioned methods and/or those described herein with reference to and as illustrated by the drawings. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station (BS) and user equipment (UE), in accordance with the present disclosure.

FIG. 3 depicts an example disaggregated base station architecture, in accordance with the present disclosure.

FIGS. 4A, 4B, 4C, and 4D depict aspects of data structures for a wireless communications network, in accordance with the present disclosure.

FIG. 5 is a diagram illustrating examples of carrier aggregation, in accordance with the present disclosure.

FIG. 6 is a diagram illustrating examples of uplink communication on multiple carriers, in accordance with the present disclosure.

FIG. 7 is a diagram illustrating an example of power headroom (PH) reporting for multiple component carriers (CCs), in accordance with the present disclosure.

FIG. 8 is a diagram illustrating an example of PH reporting for multiple CCs, in accordance with the present disclosure.

FIG. 9 is a flowchart of an example method of wireless communication.

FIG. 10 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for power headroom reporting for multiple carriers.

Power headroom (PH) reporting is a way for a user equipment (UE) to indicate a difference (“headroom”) between a maximum UE transmit power (P_{CMAX}) and an actual transmit power of the UE. A PH can be an actual PH or a virtual PH. An actual PH is determined using parameters of an actual transmission, whereas a virtual PH is determined using default/reference values. The virtual PH is used for scheduling at a network node—the network node takes the virtual PH and estimates an actual PH (referred to as a “converted PH” based on the virtual PH). There is a tendency for the converted PH to be lower than the actual PH on the same carrier would be, due to the default/reference values used to determine the virtual PH. PH reporting can be performed according to a timer. When the timer expires, the UE may transmit a PH report on the next available uplink grant. The timer may be denominated in multiples of 10 subframes.

In many situations, a UE communicates on multiple carriers. For example, a UE can communicate using uplink switching, carrier aggregation, or the like. In uplink switching, the UE switches between transmitting on a first carrier and transmitting on a second carrier. In carrier aggregation, the UE communicates simultaneously on multiple carriers. For example, the first carrier may be a primary component carrier (PCC) and the second carrier may be a secondary component carrier (SCC). As another example, the first carrier and the second carrier may both be SCCs. Each of the multiple carriers can be a frequency division duplexing (FDD) carrier or a time division duplexing (TDD) carrier. The multiple carriers can include any combination of TDD carriers and FDD carriers, and any combination of PCCs and SCCs.

Slots on a carrier can be configured as uplink slots or downlink slots. An uplink slot is a slot in which the UE can transmit an uplink communication, and a downlink slot is a slot in which the UE can receive a downlink communication.

In some circumstances, the UE may tend to report actual PHs for one of the multiple carriers (referred to as a first carrier) more often than other carriers of the multiple carriers. For example, if the first carrier is associated with a high uplink scheduling rate (denoting a large number of uplink slots scheduled in a time interval), it may be likely that the UE repeatedly reports actual PHs on the first carrier. If the UE reports an actual PH on the first carrier, the UE may therefore report a virtual PH on one or more second carriers other than the first carrier. Therefore, the UE may tend to report virtual PHs on the second carrier(s). As noted above, virtual PHs may lead to underestimation of headroom on the one or more second carriers, leading to lower transmit powers of the UE and overly conservative transmit parameter (e.g., modulation and coding scheme) selection.

Techniques and apparatuses described herein provide ways to report an actual PH on a CC x in a situation where actual PH reporting may tend to occur on another CC y. In some aspects, the UE may use a timer specific to a CC x. If the timer expires without having transmitted an actual PH on the CC x, and if a calculated virtual PH on CC x satisfies a virtual PH threshold, the UE may report a PH on CC x. The timer may be separate from a prohibit timer and/or periodic timer that is configured for general PH operation (e.g., the prohibit timer and/or periodic timer that applies to both the CC x and the CC y). In some other aspects, the UE may alternate between transmitting actual PHs on the CC x and the CC y (referred to as transmitting on a selected CC of the CC x and the CC y), unless an uplink grant is not received on the selected CC within a length of a timer. If the uplink grant is not received on the selected CC within the length of the timer, the UE may transmit the PH on a next available uplink grant (irrespective of which carrier the uplink grant is on). These techniques can also be applied for a plurality of CCs (e.g., more than two CCs).

Particular aspects of the subject matter described in this disclosure can be implemented to realize one or more of the following potential advantages. In some examples, by transmitting the PH (e.g., an additional PH) according to the timer specific to the CC x and the virtual PH threshold, the described techniques can be used to ensure that actual PH is reported for each carrier of multiple active carriers of the UE while reducing delay associated with PH reporting on the multiple carriers, thereby reducing the occurrence of decreased transmit power selection. In some examples, by alternating between transmitting PHs on the CC x and the CC y, the described techniques can be used to ensure that actual PH is reported for each carrier of multiple active carriers of the UE while reducing overhead relative to reporting an actual CC.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

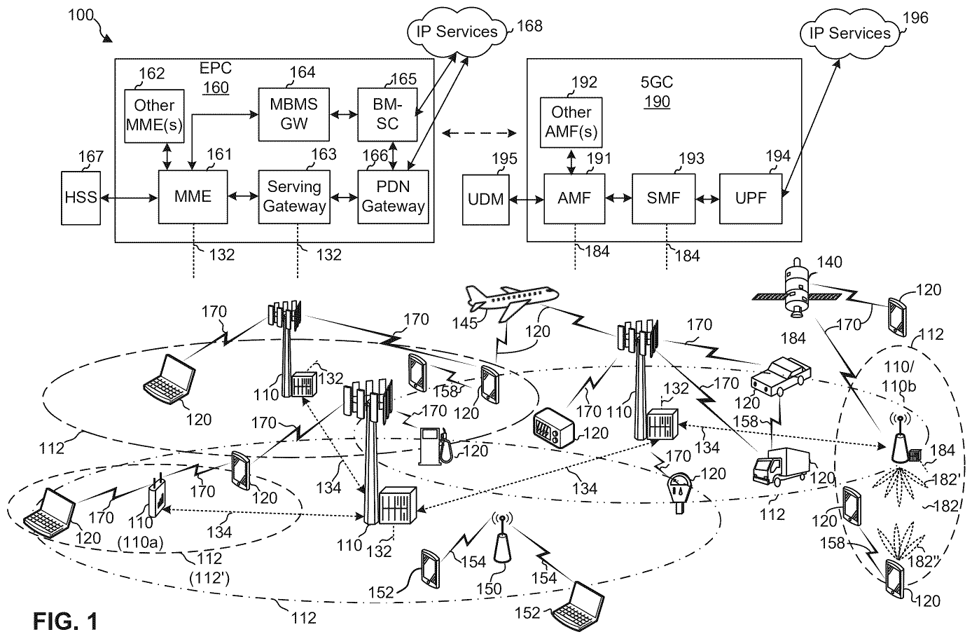

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

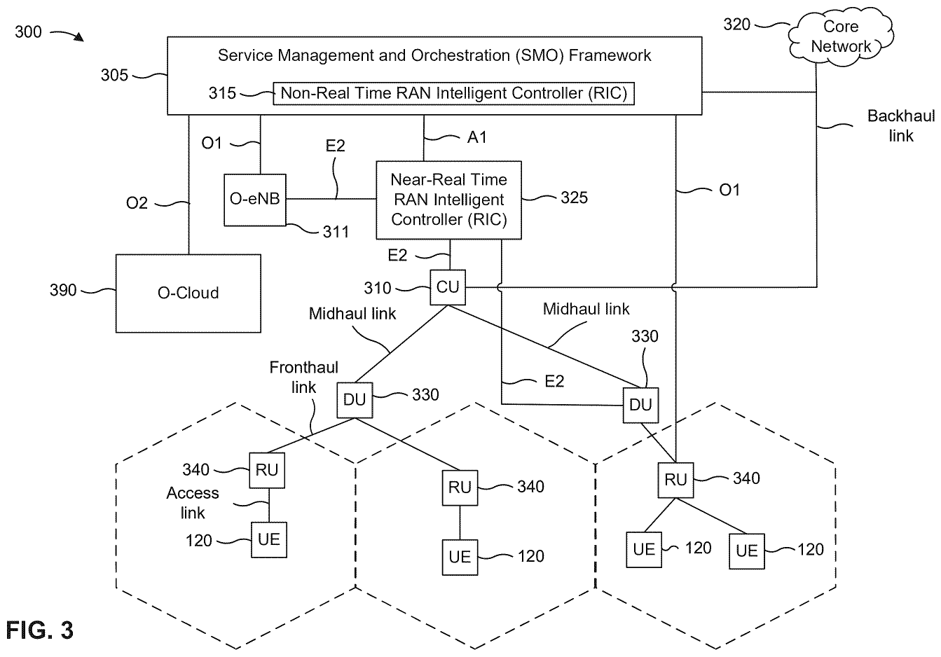

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) radio access network (RAN) Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated RAN architecture, such as an Open RAN (O-RAN) architecture or a Virtualized RAN (vRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., x2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, the 3rd Generation Partnership Project (3GPP) currently defines Frequency Range 2 (FR2) as including 24,250 MHz-52,600 MHz, which is sometimes referred to (interchangeably) as a “millimeter wave” (“mmW” or “mmWave”). A base station configured to communicate using mm Wave or near mm Wave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

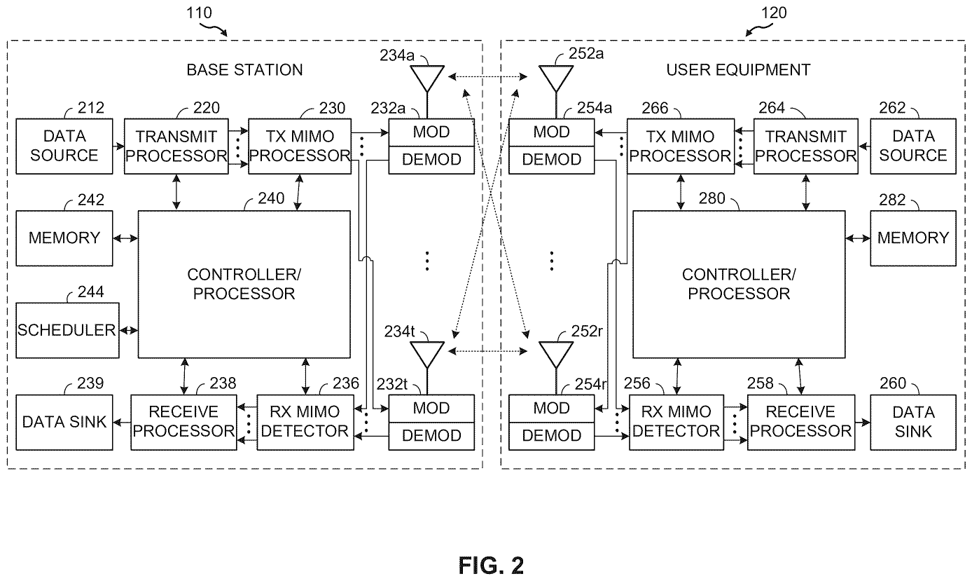

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) MIMO processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

Receive (RX) MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data. In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an O-RAN (such as the network configuration sponsored by the O-RAN Alliance), or a vRAN (also known as a cloud RAN (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture, in accordance with the present disclosure. The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

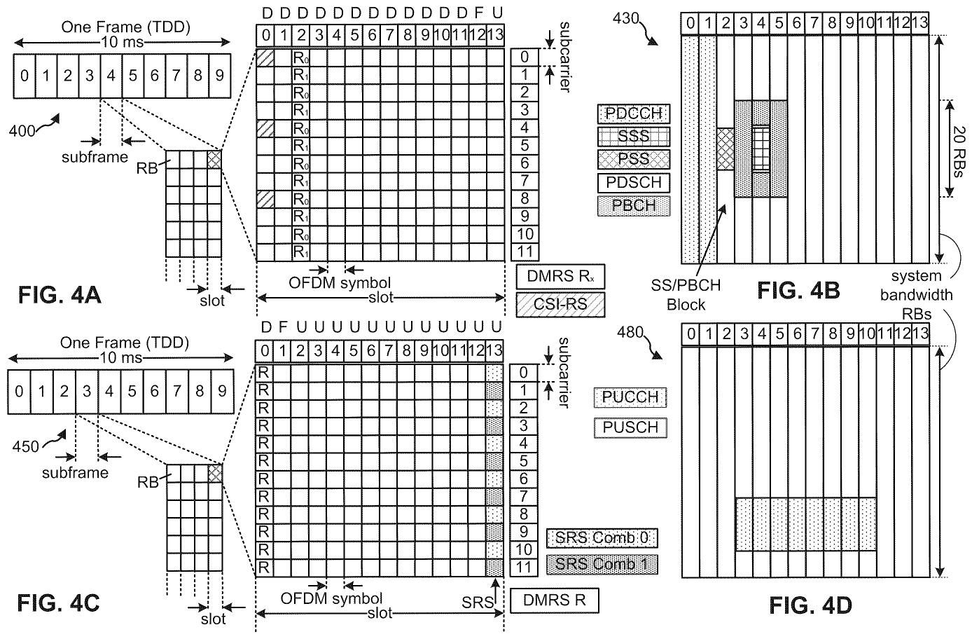

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing. OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where u is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (also referred to as an SS block (SSB)). The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

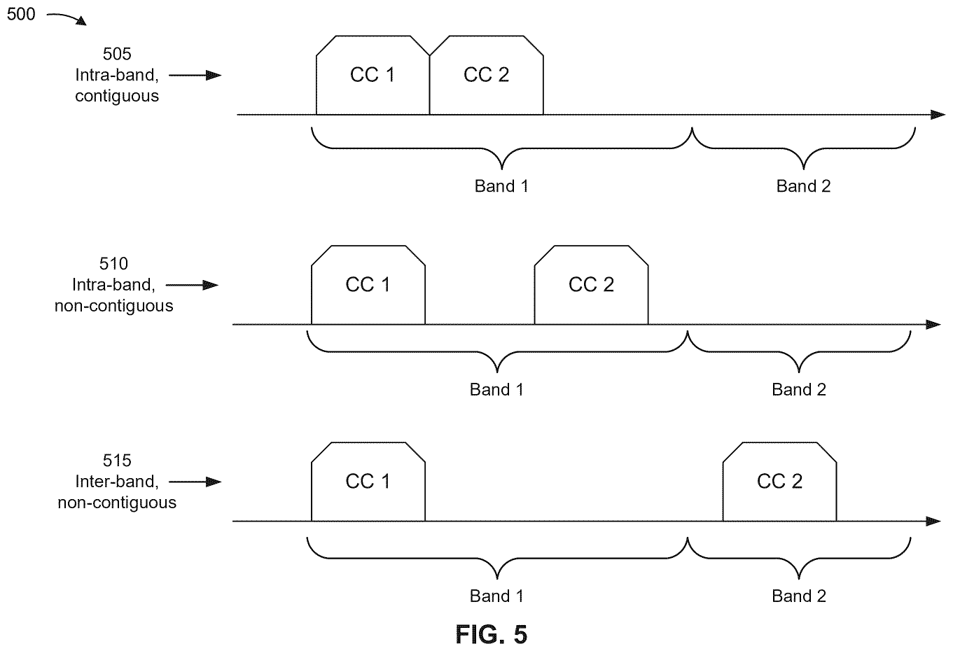

FIG. 5 is a diagram illustrating examples 500 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A BS 110 may configure carrier aggregation for a UE 120, such as in a radio resource control (RRC) message, downlink control information (DCI), and/or another signaling message.

As shown by reference number 505, in some aspects, carrier aggregation may be configured in an intra-band contiguous mode where the aggregated carriers are contiguous to one another and are in the same band. As shown by reference number 510, in some aspects, carrier aggregation may be configured in an intra-band non-contiguous mode where the aggregated carriers are non-contiguous to one another and are in the same band. As shown by reference number 515, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

Techniques described herein can be applied for a UE communicating on multiple carriers, such as two or more CCs in a carrier aggregation configuration, two or more CCs in an uplink transmission switching configuration, two or more CCs in a dual connectivity configuration, or the like.

In some aspects, the UE may communicate using a master cell group (MCG) and/or one or more secondary cell groups (SCGs). For example, the UE may initiate random access on a PCell of the MCG. The UE may use control signaling on the PCell to add one or more SCells of the MCG (e.g., for carrier aggregation). The UE may add an SCG, such as via signaling on the PCell or via random access on a secondary PCell (SPCell) belonging to the SCG. The UE may also be configured with one or more SCells of the SCG, such as via control signaling on the PCell or the PSCell. In some cases, “special cell” (SPCell) is used to refer to the PCell and the PSCell. For example, “the UE may receive signaling on an SPCell” may mean that the UE can receive this signaling on the PCell or on the PSCell. The carriers described above can be TDD carriers, FDD carriers, or a combination thereof. A PCell or a PSCell may be referred to as a primary component carrier (PCC), and an SCell may be referred to as a secondary component carrier (SCC).

As indicated above, FIG. 5 is provided as an example. Other examples may differ from what is described with regard to FIG. 5.

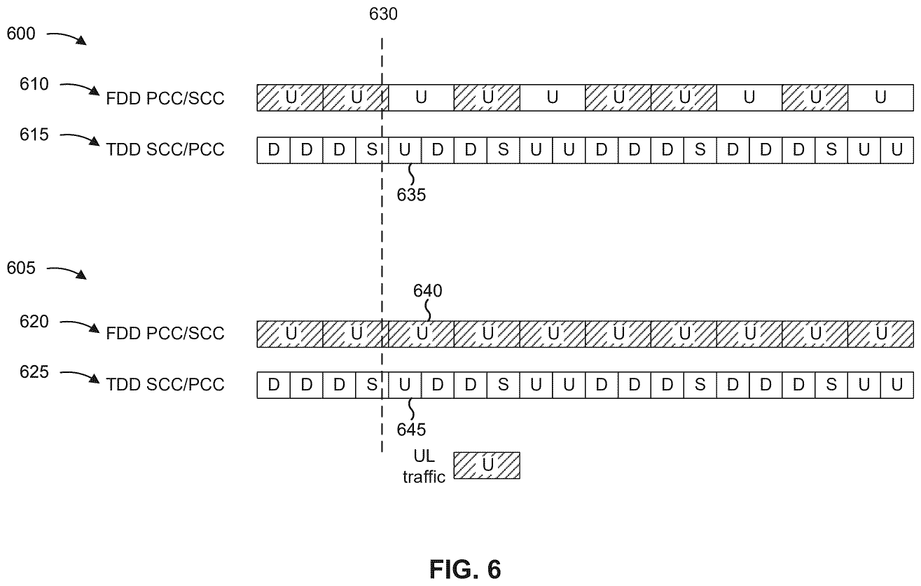

FIG. 6 is a diagram illustrating examples 600 and 605 of uplink communication on multiple carriers, implemented using an FDD carrier and a TDD carrier, in accordance with the present disclosure. In FIG. 6, the horizontal axis represents time. Each CC 610, 615, 620, and 625 includes a number of slots. Uplink slots (which include uplink symbols in which the UE can perform uplink transmission, including PH reporting) are denoted by “U.” Downlink slots (which include downlink symbols in which the UE can perform downlink reception) are denoted by “D.” Special slots, denoted by “S,” may include zero or more downlink symbols, zero or more uplink symbols, and a switching gap. Slots on the FDD CCs 610 and 620 in which the UE performs an uplink communication are indicated by a hatched fill. Slots on the FDD CCs 610 and 620 in which the UE does not perform an uplink communication do not include a hatched fill. The slots of example 600 are zero-indexed, meaning that a reference to “slot 2” on the CC 610 refers to the third illustrated slot of the CC 610 (in which the UE does not perform an uplink communication).

Example 600 is an example in which the UE uses uplink switching. In uplink switching, the UE switches between performing uplink communications on a CC 610, which is an FDD CC, and a CC 615, which is a TDD CC. The CC 610 may be a PCC or an SCC, and the CC 615 may be a PCC or an SCC. For example, the CC 610 and the CC 615 may include any combination of PCC and/or SCCs.

Example 605 is an example in which the UE uses carrier aggregation. In carrier aggregation, the UE may simultaneously perform uplink communications on a CC 620, which is an FDD CC, and on a CC 625, which is a TDD CC. The CC 620 may be a PCC or an SCC, and the CC 625 may be a PCC or an SCC. For example, the CC 620 and the CC 625 may include any combination of PCC and/or SCCs.

A PH value may indicate an amount of remaining transmission power available to a UE in addition to power being used by a current transmission. The PH value may be based at least in part on a difference between a UE maximum transmission power and a PUSCH transmission power. A PH report may be a Type 1 report for a PUSCH, a Type 3 report for an SRS, or a Type 2 report for a physical uplink control channel (PUCCH) (all referred to as “PH reports” or “PH reporting”). For example, types of UE PHRs may include a Type 1 UE power headroom that is valid for a PUSCH transmission occasion i on an active uplink bandwidth part (BWP) b of carrier f of serving cell c, or a Type 3 UE power headroom that is valid for an SRS transmission occasion i on an active uplink BWP b of carrier f of serving cell c. Thus, a PHR report may be determined for a CC or serving cell.

A UE may determine whether a PH for an activated serving cell is based at least in part on an actual transmission (referred to as an actual PH). The actual transmission may be based at least in part on higher layer signalling of configured grant and periodic/semi-persistent SRS transmissions, or DCI signalling received by the UE. The UE may determine whether the PH report for the activated serving cell is based at least in part on an uplink transmission format. The uplink transmission format may be based at least in part on default parameters, or parameters indicated by DCI signalling received at the UE. The parameters may include the resource allocation parameters, transmit power control parameters, or modulation parameters, among other examples. A PH for an activated serving cell may be referred to as a virtual PH or may be provided via a virtual PH. “Virtual PH” may refer to a PH that is estimated by the UE using one or more default power control parameters and is based on a default uplink transmission. For example, a virtual PH may not be associated with an actual transmission by the UE (for example, a virtual PH may not be associated with a DCI scheduled PUSCH occasion). Rather, the UE may use the one or more default power control parameters to estimate the virtual PH (for example, rather than using power control parameters associated with an actual transmission). The network entity may then use the virtual PH to perform communication operations such as scheduling or link configuration by converting the virtual PH to a converted PH. As used herein, “PUSCH occasion” may refer to one or more time-frequency resources that are associated with a PUSCH communication. For example, DCI may indicate, or allocate, the one or more time-frequency resources when scheduling the PUSCH communication.

When a UE determines that a Type 1 PH for an activated serving cell is based at least in part on an actual PUSCH transmission, for a PUSCH transmission occasion i on an active uplink BWP b of carrier f of serving cell c, the UE may compute the Type 1 PH as:

$${P}_{c max . f . c} - ( {P}_{0 \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot P {L}_{b , f , c} ( {q}_{d} ) + {Δ}_{T F , b , f , c} ( i ) + {f}_{b , f , c} ( i , l ) ) .$$

With respect to the Type 1 PH (in decibels (dB)) based at least in part on an actual PUSCH transmission, P_{CMAX}_{_{,f,c}}(i) may represent a UE configured maximum output power after backoff due to power management (for example, backoff due to a maximum power reduction), and

$${P}_{O \_ PUSCH , b , f , c} ( j ) , {M}_{RB , b , f , c}^{PUSCH} ( i ) , {α}_{b , f , c} ( j ) , {PL}_{b , f , c} ( {q}_{d} ) , {Δ}_{TF , b , f , c} ( i )$$

and f_{b,f,c}(i, l) may be parameters used to determine a PUSCH transmit power.

The UE may compute a virtual PH for a PUSCH transmission occasion i on an active uplink BWP b of carrier f of serving cell c as: P_{cmax,f,c}−(P₀_{_{PUSCH}}_{,b,f,c}(0)+Δ_{PREAMBLE}_{_{Msg3}}+α_{b,f,c}(j)·PL_{b,f,c}(q_{d})+f_{b,f,c}(i, l). With respect to the Type 1 PH (in dB) based at least in part on a reference PUSCH transmission (for example, a virtual power headroom report), P̅_{CMAX}_{_{,f,c}} may be computed assuming no backoff (for example, maximum power reduction (MPR) values may be assumed to be 0 dB), and P_{O_PUSCH,b,f,c}(0), α_{b,f,c}(j), PL_{b,f,c}(q_{d}), and f_{b,f,c}(i, l) may be based at least in part on default or reference parameters of j, i, l, and q_{d}, where for Pa and alpha, p0-PUSCH-AlphaSetId is equal to 0, and for path loss, pusch-PathlossReferenceRS-Id is equal to 0, and for closedloopindex, l is equal to 0.

A PH report may be triggered by a MAC layer, and the PH report may be triggered based at least in part on an occurrence of one or more triggering events. For example, the PH report may be triggered by a set of timers, such as a phr-PeriodicTimer or a phr-ProhibitTimer. The PH report may be triggered by a power change that satisfies a configurable threshold for a pathloss reference signal used for power control in an uplink component carrier. The PH report may be triggered by an activation of an SCell. The PH report may be triggered when an active BWP of a configured component carrier is changed from a dormant state to a non-dormant state. One or more of the above timers (in particular, phr-PeriodicTimer) may be configured in multiples of 10 subframes.

A triggered PH report may be transmitted in a PH report MAC-CE on a first available PUSCH corresponding to an initial transmission of a transport block that can accommodate the PHR MAC-CE as a result of logical channel prioritization. The PUSCH may be dynamic (for example, scheduled by DCI), or the PUSCH can be a configured-grant PUSCH.

As a first example of PH reporting, if a PH report is triggered at a time 630 in example 600, and if a next available uplink grant is in slot 4 of the CC 615, as shown by reference number 635, the UE may report an actual PH for the CC 615 and a virtual PH for the CC 610 (since no transmission is scheduled on the CC 610 in the slot that overlaps slot 4 of the CC 615). As a second example of PH reporting, if a PH report is triggered at the time 630 in example 605, the UE may transmit a first PH report indicating an actual PH on the CC 620 in slot 2 of the CC 620 (as shown by reference number 640) and a second PH report indicating an actual PH on the CC 625 in slot 4 of the CC 625 (as indicated by reference number 645). The first PH report may also indicate a virtual PH of the CC 625, and the second PH report may also indicate a virtual PH of the CC 620.

In a situation where a given CC (e.g., the FDD CC) is associated with a high uplink scheduling rate, the triggered PH report may tend to be transmitted on the given CC, due to a large number of uplink grants occurring on the given CC and one or more timers for PH reporting being configured in multiples of 10 subframes. This may lead to a situation in which PH reporting tends to provide virtual PHs for one or more CCs, causing conservative determination of transmit power parameters and thus decreased transmit power.

As indicated above, FIG. 6 is provided as an example. Other examples may differ from what is described with regard to FIG. 6.

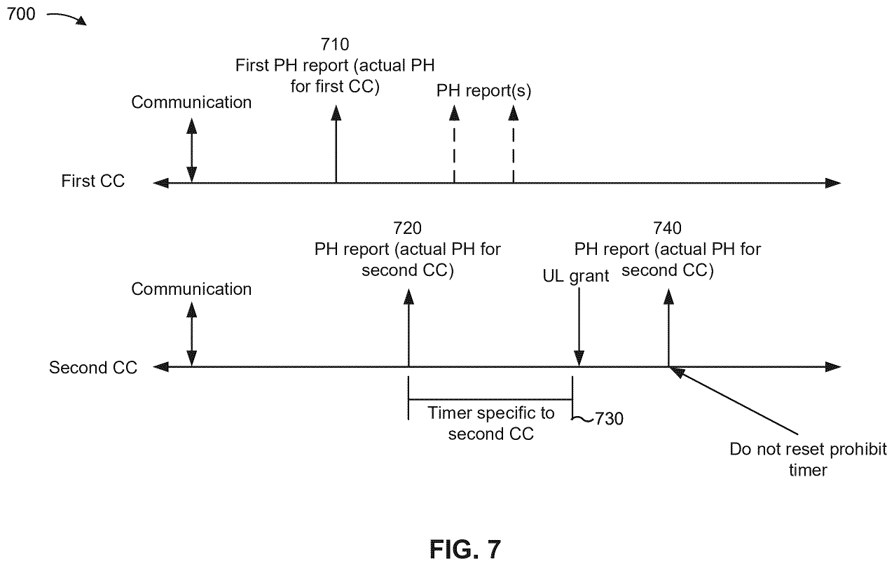

FIG. 7 is a diagram illustrating an example 700 of PH reporting for multiple CCs, in accordance with the present disclosure. Example 700 includes a first CC and a second CC, though the techniques described herein can be implemented for any number of CCs. For example, operations described with regard to the second CC may be performed with regard to one or more second CCs. Transmissions by a UE on a given CC are indicated by upward arrows. Receptions by the UE on a given CC are indicated by downward arrows. As shown, the UE may communicate on the first CC and the second CC. Example 700 is an example in which the UE transmits an additional PH report on the second CC, such as when no PH report has been transmitted on the second CC for a length of time.

As shown by reference number 710, the UE may transmit a first PH report on the first CC. The first PH report may be triggered as described elsewhere herein. The first PH report may indicate an actual PH for the first CC, as described elsewhere herein. The first PH report may also indicate a virtual PH for the second CC (or a respective virtual PH corresponding to each of multiple second CCs).

As shown by reference number 720, the UE may transmit a PH report on the second CC. The PH report on the second CC may include an actual PH for the second CC. Additionally, or alternatively, the PH report on the second CC may include a virtual PH for the first CC. Upon transmitting the PH report on the second CC, the UE may start a timer specific to the second CC. The timer specific to the second CC may be referred to herein as CCxPHRTimer. In some aspects, the timer specific to the second CC may be defined in terms of a timer applicable to all CCs of the UE, such as a phr-PeriodicTimer. For example, the timer specific to the second CC may be defined as x*phr-PeriodicTimer, wherein x can be any configured or specified value. If the UE transmits a PH report on the second CC (which may include an actual PH for the second CC), the UE may reset the timer specific to the second CC. In the case where there are multiple second CCs, each second CC may be associated with a respective timer specific to each second CC.

As shown by reference number 730, the timer specific to the second CC may expire. As shown by reference number 740, the UE may transmit a second PH report on the second CC associated with at least one of the timer specific to the second CC or a virtual PH threshold. For example, the UE may transmit the second PH report on the second CC, using a new uplink grant on the second CC, in accordance with the timer specific to the second CC having expired with no PH reporting having been transmitted on the second CC within a time length of the timer. As another example, the UE may transmit the second PH report on the second CC in accordance with a virtual PH value corresponding to the second CC (e.g., a virtual PH for the second CC, which may include a virtual PH reported at reference number 710 or a virtual PH calculated separately from the reporting shown by reference number 710) satisfying a virtual PH threshold (e.g., vPH_threshold). In some aspects, the virtual PH threshold may be defined relative to a PH value. For example, the virtual PH threshold may be defined relative to a maximum PH value (e.g., 38 decibel milliwatts (dBm), 40 dBm). As another example, the virtual PH threshold may be defined as the maximum PH value plus a constant (e.g., 38 dBm+2 dBm). Thus, the UE may report the actual PH only if the virtual PH is expected to contribute to underestimation of PH on the second CC. Upon transmitting the second PH report on the second CC, the UE may not reset a prohibit timer. Thus, the second PH report may be considered an additional PH report. The second PH report may indicate an actual PH for the second CC.

Below is some example pseudocode that implements aspects of example 700.

```
Define: CCxPHRTimer = Y * phr-PeriodicTimer
Define: vPH_threshold = 38+2 by default.
1> if UE send PHR on CC x
  2> CC x's CCxPHRTimer reset
1> if CC x's CCxPHRTimer expiry
  2> if last CC x's virtual PH (vPH) > vPH_threshold
    3> if there is a new Tx UL grant on CC x
      4> choose this UL grant for PHR report
      4> Do not reset phr-ProhibitTimer
```

In the above pseudocode, x represents an index of an uplink CC of the UE, which may be selected from a plurality of CCs. For example, the UE may apply the operations of example 700 for any number of CCs. In this example, each CC of the plurality of CCs may be associated with a respective timer (CCxPHRTimer). Upon expiration of a given CC's timer, if the given CC's virtual PH satisfies a threshold and there is an uplink grant on the given CC, the UE may transmit a PH report on the given CC.

As indicated above, FIG. 7 is provided as an example. Other examples may differ from what is described with regard to FIG. 7.

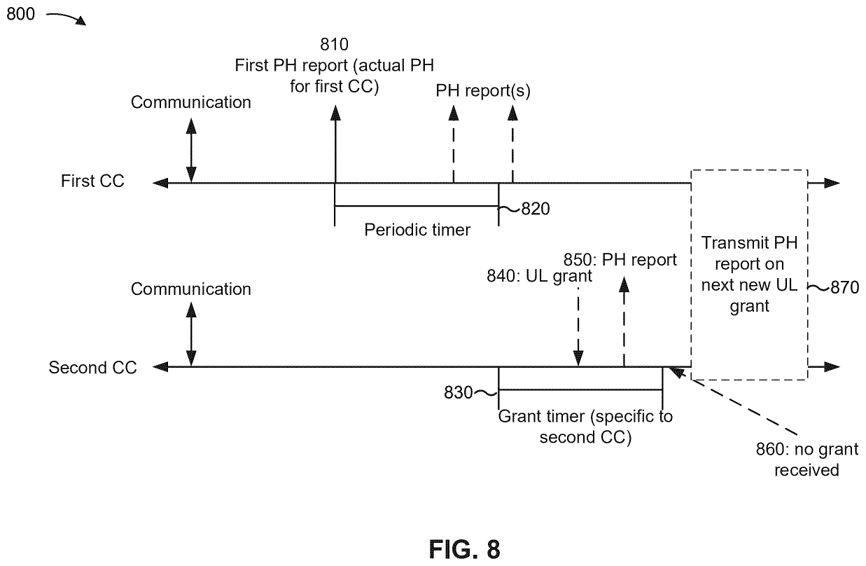

FIG. 8 is a diagram illustrating an example 800 of PH reporting for multiple CCs, in accordance with the present disclosure. Example 800 includes a first CC and a second CC, though the techniques described herein can be implemented for any number of CCs. Transmissions by a UE on a given CC are indicated by upward arrows. Receptions by the UE on a given CC are indicated by downward arrows. As shown, the UE may communicate on the first CC and the second CC. Example 800 is an example in which the UE alternates transmission of PH reporting on the first CC and the second CC.

As shown by reference number 810, the UE may transmit a first PH report on the first CC. The first PH report may be triggered as described elsewhere herein. The first PH report may indicate an actual PH for the first CC, as described elsewhere herein. The first PH report may also indicate a virtual PH for the second CC (or a respective virtual PH corresponding to each of multiple second CCs).

As shown by reference number 820, a periodic timer (e.g., phr-PeriodicTimer) may expire after transmission of the first PH report. Furthermore, a scheduling rate on the first CC or the second CC may satisfy a threshold. For example, the scheduling rate may include an uplink scheduling rate (e.g., on a TDD CC) within a duration. In some aspects, the duration may be relative to the periodic timer. For example, the duration may include y*phr-PeriodicTimer, where y can include any value. As shown by reference number 830, the expiration of the periodic timer may start a timer specific to the second CC. The timer specific to the second CC may be referred to as a grant timer (e.g., GrantTimer). In some aspects, the timer specific to the second CC may be based at least in part on the scheduling rate and/or the periodic timer. For example, the timer specific to the second CC may be defined as GrantTimer=max(10 slots, (1−SchedulingRate)*phr-PeriodicTimer), wherein SchedulingRate is the scheduling rate.

As shown by reference number 840, in a first example, the UE may receive a new uplink grant for the second CC within a time length of the grant timer. Thus, as shown by reference number 850, the UE may transmit a PH on the second CC. In this way, the UE may transmit a PH on the second CC if a previous PH (e.g., a most recent PH) was transmitted on the first CC, if the periodic timer expires, and if a new uplink grant is received on the second CC within a time length of a grant timer.

In some aspects, the UE may transmit the second PH report on the second CC in accordance with a virtual PH value corresponding to the second CC (e.g., a virtual PH for the second CC, which may include a virtual PH reported as shown by reference number 810 or a virtual PH calculated separately from the reporting shown by reference number 810) satisfying a virtual PH threshold (e.g., vPH_threshold). In some aspects, the virtual PH threshold may be defined relative to a PH value. For example, the virtual PH threshold may be defined relative to a maximum PH value (e.g., 38 dBm, 40 dBm). As another example, the virtual PH threshold may be defined as the maximum PH value plus a constant (e.g., 38 dBm+2 dBm). Thus, the UE may report the actual PH on the second CC only if the virtual PH is expected to contribute to underestimation of PH on the second CC.

As shown by reference number 860, in a second example, the UE may not receive a new uplink grant on the second CC within the time length of the grant timer. Thus, as shown by reference number 870, the UE may transmit the PH report on a next new uplink grant, irrespective of which CC the next new uplink grant is received on. For example, the UE may wait for a new uplink grant on all CCs of example 800.

It should be noted that example 800 can be applied for either CC of example 800. For example, the transmission of a PH report at reference number 810 may occur on the second CC, and then the techniques of example 800 may provide for PH transmission on the first CC (e.g., using a GrantTimer specific to the first CC).

Below is an example of pseudocode that implements aspects of example 800.

```
  Define: SchedulingRate = TDD CC UL scheduling in last duration of x * phr-
PeriodicTimer
  Define: GrantTimer =max(10slots,(1- SchedulingRate)* phr-PeriodicTimer)
  Define: SR_Threshold = 0.2 (default value)
  Define: vPH_threshold = 38+2 by default
  1>If SchedulingRate > SR_Threshold
    2> (if previous PH sending on CC0) && (CC 1's virtual PH (vPH) >
vPH_threshold )
      3> if phr-PeriodicTimer expire
        4> wait New Tx UL grant on CC1
        4> start GrantTimer
          5> if UE receive New Tx UL grant on CC1 && GrantTimer does not
    expire
            6> sending PH on CC1
          5> if GrantTimer expire && UE does not receive New Tx UL grant on
    CC1
            6> wait new Tx grant on both CCs
    2> (if previous PH sending on CC1) && (CC 0's vPH > vPH_threshold )
      3> if phr-PeriodicTimer expire
        4> wait New Tx UL grant on CC0
        4> start GrantTimer
          5> if UE receives New Tx UL grant on CC0 && GrantTimer does not
    expire
            6> sending PH on CC0
          5> if GrantTimer expire && UE does not receive New Tx UL grant on
    CC0
            6> wait new Tx grant on both CCs
```

Thus, the UE may alternate between PH transmission on the first CC and on the second CC (due to the condition “if previous PH sending on CC0” or “if previous PH sending on CC1”) unless no uplink grant is available on the selected CC within the grant timer (e.g., a timer specific to the selected CC), or the selected CC's virtual PH does not satisfy a virtual PH threshold.

As indicated above, FIG. 8 is provided as an example. Other examples may differ from what is described with regard to FIG. 8.

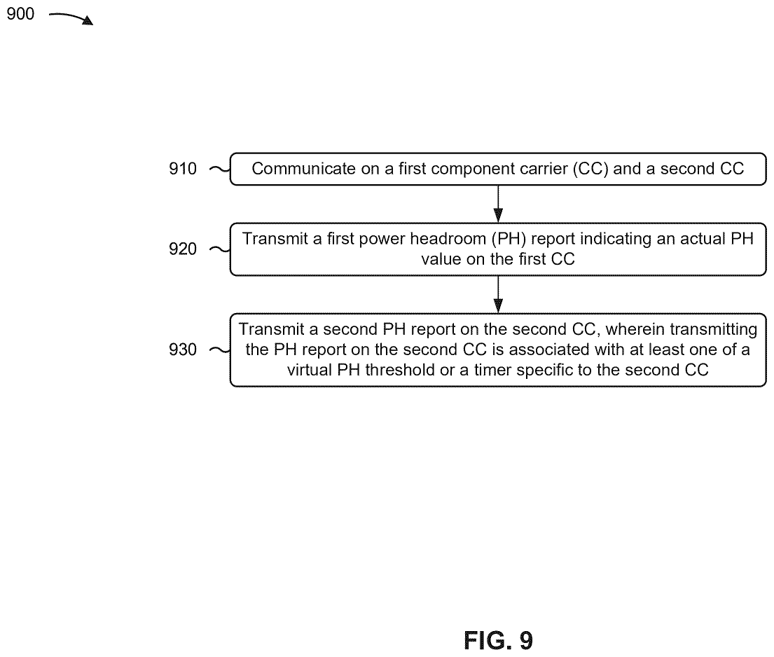

FIG. 9 is a flowchart of an example method 900 of wireless communication. The method 900 may be performed by, for example, a UE (e.g., UE 120) or an apparatus of a UE.

Method 900 begins at 910 with communicating on a first CC and a second CC. For example, the UE may communicate on a first CC and a second CC, as described above in connection with, for example, FIGS. 7 and 8, and in general with regard to FIG. 5. In some aspects, the UE may communicate on a plurality of carriers including the first CC and the second CC.

Method 900 then proceeds at 920 with transmitting a first PH report indicating an actual PH value on the first CC. For example, the UE may transmit a first PH report indicating an actual PH value on the first CC, as described above in connection with, for example, FIG. 7 at 710 and FIG. 8 at 810.

Method 900 then proceeds at 930 with transmitting a second PH report on the second CC, wherein transmitting the PH report on the second CC is associated with at least one of a virtual PH threshold or a timer specific to the second CC. For example, the UE may transmit a second PH report on the second CC. Transmitting the PH report on the second CC may be associated with at least one of a virtual PH threshold (vPH_Threshold) or a timer specific to the second CC (CCxPHRTimer or GrantTimer), as described above in connection with, for example, FIG. 7 at 750 and FIG. 8 at 830.

In some aspects, transmitting the second PH report on the second CC further comprises transmitting the second PH report on the second CC based at least in part on a previous virtual PH value corresponding to the second CC.

In some aspects, transmitting the first PH report on the first CC further comprises transmitting the first PH report on the first CC within a time length of a prohibit timer relative to transmitting the second PH report on the second CC.

In some aspects, transmitting the second PH report on the second CC further comprises transmitting the second PH report on the second CC based at least in part on the timer that is specific to the second CC.

In some aspects, the timer is associated with a time length, and transmitting the second PH report on the second CC further comprises transmitting the second PH report on the second CC in response to no PH report having been transmitted on the second CC within the time length.

In some aspects, transmitting the second PH report further comprises transmitting the second PH report in accordance with a virtual PH value corresponding to the second CC satisfying the virtual PH threshold.

In some aspects, transmitting the second PH report on the second CC further comprises transmitting the second PH report on the second CC in accordance with a scheduling rate on a CC, of the first CC or the second CC, satisfying a threshold.

In some aspects, transmitting the PHR report on the second CC further comprises transmitting the PHR report on the second CC using an uplink grant, on the second CC, received within a time length of the timer specific to the second CC, wherein the timer specific to the second CC is triggered by expiration of a periodic timer.

In some aspects, method 900 includes transmitting the second PH report on the second CC after no uplink grant on the first CC is received within a time length of a timer specific to the first CC.

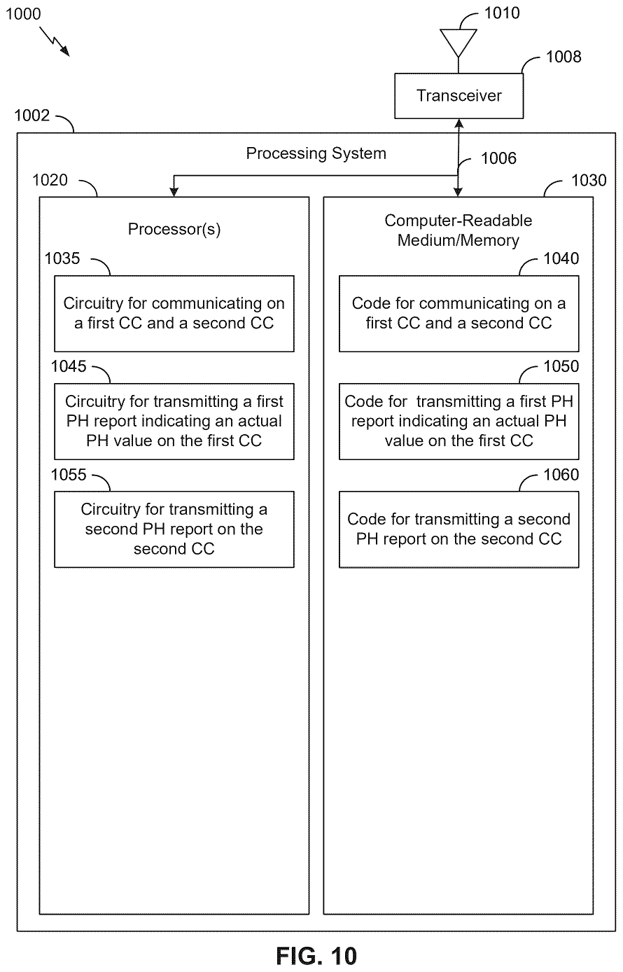

In one aspect, method 900, or any aspect related to it, may be performed by an apparatus, such as communications device 1000 of FIG. 10, which includes various components operable, configured, or adapted to perform the method 900. Communications device 1000 is described below in further detail in connection with FIG. 10.

Although FIG. 9 shows example blocks of method 900, in some aspects, method 900 may include additional blocks, fewer blocks, different blocks, or differently arranged blocks than those depicted in FIG. 9. Additionally, or alternatively, two or more of the blocks of method 900 may be performed in parallel.

FIG. 10 is a diagram illustrating an example of an implementation of code and circuitry for a communications device 1000, in accordance with the present disclosure. The communications device 1000 may be a UE, or a UE may include the communications device 1000. The communications device 1000 may be referred to herein as an apparatus. The communications device 1000 may be configured for wireless communication.

The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes one or more processors 1020. In various aspects, the one or more processors 1020 may be representative of one or more of receive processor 258, transmit processor 264, TX MIMO processor 266, and/or controller/processor 280, as described with respect to FIG. 2. The one or more processors 1020 are coupled to a computer-readable medium/memory 1030 (comprising one or more memories) via a bus 1006. In various aspects, the computer-readable medium/memory 1030 may be representative of memory 282, as described with respect to FIG. 2. In certain aspects, the computer-readable medium/memory 1030 is configured to store instructions (e.g., computer-executable code, processor-executable code) that when executed by the one or more processors 1020, cause the one or more processors 1020 to perform the method 900 described with respect to FIG. 9, or any aspect related to it. The one or more processors 1020 may be configured to execute the instructions. Note that reference to a processor performing a function of communications device 1000 may include one or more processors performing that function of communications device 1000.

As shown in FIG. 10, the communications device 1000 may include circuitry for communicating on a first CC and a second CC (circuitry 1035).

As shown in FIG. 10, the communications device 1000 may include, stored in computer-readable medium/memory 1030, code for communicating on a first CC and a second CC (code 1040).

As shown in FIG. 10, the communications device 1000 may include circuitry for transmitting a first PH report indicating an actual PH value on the first CC (circuitry 1045).

As shown in FIG. 10, the communications device 1000 may include, stored in computer-readable medium/memory 1030, code for transmitting a first PH report indicating an actual PH value on the first CC (code 1050).

As shown in FIG. 10, the communications device 1000 may include circuitry for transmitting a second PH report on the second CC (circuitry 1055).

As shown in FIG. 10, the communications device 1000 may include, stored in computer-readable medium/memory 1030, code for transmitting a second PH report on the second CC (code 1060).

Various components of the communications device 1000 may provide means for performing the method 900 described with respect to FIG. 9, or any aspect related to it. For example, means for transmitting, sending, or outputting for transmission may include the transceiver(s) 254 and/or antenna(s) 252 of the UE 120 and/or transceiver 1008 and antenna 1010 of the communications device 1000 in FIG. 10. Means for receiving or obtaining may include the transceiver(s) 254 and/or antenna(s) 252 of the UE 120 and/or transceiver 1008 and antenna 1010 of the communications device 1000 in FIG. 10.

FIG. 10 is provided as an example. Other examples may differ from what is described in connection with FIG. 10.

The following provides an overview of some Aspects of the present disclosure:

Aspect 1: A method of wireless communication performed by a user equipment (UE), comprising: communicating on a first component carrier (CC) and a second CC; and transmitting a first power headroom (PH) report indicating an actual PH value on the first CC; and transmitting a second PH report on the second CC, wherein transmitting the PH report on the second CC is associated with at least one of a virtual PH threshold or a timer specific to the second CC.

Aspect 2: The method of Aspect 1, wherein transmitting the second PH report on the second CC further comprises transmitting the second PH report on the second CC based at least in part on a previous virtual PH value corresponding to the second CC.

Aspect 3: The method of any of Aspects 1-2, wherein transmitting the first PH report on the first CC further comprises transmitting the first PH report on the first CC within a time length of a prohibit timer relative to transmitting the second PH report on the second CC.

Aspect 4: The method of any of Aspects 1-3, wherein transmitting the second PH report on the second CC further comprises transmitting the second PH report on the second CC based at least in part on the timer that is specific to the second CC.

Aspect 5: The method of Aspect 4, wherein the timer is associated with a time length, and wherein transmitting the second PH report on the second CC further comprises transmitting the second PH report on the second CC in response to no PH report having been transmitted on the second CC within the time length.

Aspect 6: The method of any of Aspects 1-5, wherein transmitting the second PH report further comprises transmitting the second PH report in accordance with a virtual PH value corresponding to the second CC satisfying the virtual PH threshold.

Aspect 7: The method of any of Aspects 1-6, wherein transmitting the second PH report on the second CC further comprises transmitting the second PH report on the second CC in accordance with a scheduling rate on a CC, of the first CC or the second CC, satisfying a threshold.

Aspect 8: The method of any of Aspects 1-7, wherein transmitting the PHR report on the second CC further comprises transmitting the PHR report on the second CC using an uplink grant, on the second CC, received within a time length of the timer specific to the second CC, wherein the timer specific to the second CC is triggered by expiration of a periodic timer.

Aspect 9: The method of any of Aspects 1-8, further comprising transmitting, prior to transmitting the second PH report, another PH report on the second CC, wherein transmitting the second PH report on the second CC further comprises transmitting the second PH report on the second CC after no uplink grant on the first CC is received within a time length of a timer specific to the first CC.

Aspect 10: The method of any of Aspects 19, wherein the second CC is one of a plurality of second CCs, wherein each second CC of the plurality of second CCs is associated with a respective timer specific to each second CC.

Aspect 11: The method of Aspect 10, further comprising transmitting a third PH report on another second CC of the plurality of second CCs based at least in part on a respective timer specific to the other second CC.

Aspect 12: An apparatus for wireless communication at a device, comprising a processor; memory coupled with the processor; and instructions stored in the memory and executable by the processor to cause the apparatus to perform the method of one or more of Aspects 1-1.

Aspect 13: A device for wireless communication, comprising a memory and one or more processors coupled to the memory, the one or more processors configured to perform the method of one or more of Aspects 1-11.

Aspect 14: An apparatus for wireless communication, comprising at least one means for performing the method of one or more of Aspects 1-11.

Aspect 15: A non-transitory computer-readable medium storing code for wireless communication, the code comprising instructions executable by a processor to perform the method of one or more of Aspects 1-11.

Aspect 16: A non-transitory computer-readable medium storing a set of instructions for wireless communication, the set of instructions comprising one or more instructions that, when executed by one or more processors of a device, cause the device to perform the method of one or more of Aspects 1-11.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Reference to an element in the singular is not intended to mean only one unless specifically so stated, but rather “one or more.” For example, reference to an element (e.g., “a processor,” “a controller,” “a memory,” etc.), unless otherwise specifically stated, should be understood to refer to one or more elements (e.g., “one or more processors,” “one or more controllers,” “one or more memories,” etc.).

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus configured for wireless communication, comprising:
one or more memories comprising processor-executable instructions; and
one or more processors configured to execute the processor-executable instructions and cause the apparatus to:
communicate on a first component carrier (CC) and a second CC; and
transmit a first power headroom (PH) report indicating an actual PH value on the first CC; and
transmit a second PH report on the second CC, wherein transmitting the PH report on the second CC is associated with at least one of a virtual PH threshold or a timer specific to the second CC.

2. The apparatus of claim 1, wherein the one or more processors, to cause the apparatus to transmit the second PH report on the second CC, are configured to cause the apparatus to transmit the second PH report on the second CC based at least in part on a previous virtual PH value corresponding to the second CC.

3. The apparatus of claim 1, wherein the one or more processors, to cause the apparatus to transmit the first PH report on the first CC, are configured to cause the apparatus to transmit the first PH report on the first CC within a time length of a prohibit timer relative to transmitting the second PH report on the second CC.

4. The apparatus of claim 1, wherein the one or more processors, to cause the apparatus to transmit the second PH report on the second CC, are configured to cause the apparatus to transmit the second PH report on the second CC based at least in part on the timer that is specific to the second CC.

5. The apparatus of claim 4, wherein the timer is associated with a time length, and wherein the one or more processors, to cause the apparatus to transmit the second PH report on the second CC, are configured to cause the apparatus to transmit the second PH report on the second CC in response to no PH report having been transmitted on the second CC within the time length.

6. The apparatus of claim 1, wherein the one or more processors, to cause the apparatus to transmit the second PH report on the second CC, are configured to cause the apparatus to transmit the second PH report in accordance with a virtual PH value corresponding to the second CC satisfying the virtual PH threshold.

7. The apparatus of claim 1, wherein the one or more processors, to cause the apparatus to transmit the second PH report on the second CC, are configured to cause the apparatus to transmit the second PH report on the second CC in accordance with a scheduling rate on a CC, of the first CC or the second CC, satisfying a threshold.

8. The apparatus of claim 1, wherein the one or more processors, to cause the apparatus to transmit the second PH report on the second CC, are configured to cause the apparatus to transmit the second PH report on the second CC using an uplink grant, on the second CC, received within a time length of the timer specific to the second CC, wherein the timer specific to the second CC is triggered by expiration of a periodic timer.

9. The apparatus of claim 1, wherein the one or more processors are further configured to cause the apparatus to transmit, prior to transmitting the second PH report, another PH report on the second CC, wherein the one or more processors, to cause the apparatus to transmit the second PH report on the second CC, are configured to cause the apparatus to transmit the second PH report on the second CC after no uplink grant on the first CC is received within a time length of a timer specific to the first CC.

10. The apparatus of claim 1, wherein the second CC is one of a plurality of second CCs, wherein each second CC of the plurality of second CCs is associated with a respective timer specific to each second CC.

11. The apparatus of claim 10, wherein the one or more processors are configured to cause the apparatus to transmit a third PH report on another second CC of the plurality of second CCs based at least in part on a respective timer specific to the other second CC.

12. A method of wireless communication performed by a user equipment (UE), comprising:
communicating on a first component carrier (CC) and a second CC; and
transmitting a first power headroom (PH) report indicating an actual PH value on the first CC; and
transmitting a second PH report on the second CC, wherein transmitting the PH report on the second CC is associated with at least one of a virtual PH threshold or a timer specific to the second CC.

13. (canceled)

14. (canceled)

15. The method of claim 12, wherein the method transmits the second PH report on the second CC by transmitting the second PH report on the second CC based at least in part on a previous virtual PH value corresponding to the second CC.

16. The method of claim 12, wherein the method transmits the first PH report on the first CC by transmitting the first PH report on the first CC within a time length of a prohibit timer relative to transmitting the second PH report on the second CC.

17. The method of claim 12, wherein the method transmits the second PH report on the second CC by transmitting the second PH report on the second CC based at least in part on the timer that is specific to the second CC.

18. The method of claim 12, wherein the method transmits the second PH report on the second CC by transmitting the second PH report in accordance with a virtual PH value corresponding to the second CC satisfying the virtual PH threshold.

19. The method of claim 12, wherein the method transmits the second PH report on the second CC by transmitting the second PH report on the second CC in accordance with a scheduling rate on a CC, of the first CC or the second CC, satisfying a threshold.

20. The method of claim 12, wherein the method transmits the second PH report on the second CC by transmitting the second PH report on the second CC using an uplink grant, on the second CC, received within a time length of the timer specific to the second CC, wherein the timer specific to the second CC is triggered by expiration of a periodic timer.

21. The method of claim 12, wherein the method comprises transmitting, prior to transmitting the second PH report, another PH report on the second CC, wherein the method transmits the second PH report on the second CC by transmitting the second PH report on the second CC after no uplink grant on the first CC is received within a time length of a timer specific to the first CC.

22. The method of claim 12, wherein the second CC is one of a plurality of second CCs, wherein each second CC of the plurality of second CCs is associated with a respective timer specific to each second CC.
